(19) United States
(12) Patent Application Publication
(10) Pub. No.: US 2025/0369456 A1
(43) Pub. Date: Dec. 4, 2025

(54) MECHANICAL DEFLECTION ENERGY STORAGE DEVICE

(71) Applicant: Augustine Palena, Vancouver, WA (US)

(72) Inventor: Augustine Palena, Vancouver, WA (US)

(21) Appl. No.: 19/220,432

(22) Filed: May 28, 2025

Related U.S. Application Data
(60) Provisional application No. 63/653,665, filed on May 30, 2024.

(51) Int. Cl. F15B 1/027

(52) U.S. Cl. CPC F15B 1/027

(57) ABSTRACT

Apparatus and associated methods relate to an elastic modulus energy storage device. The energy storage device may, for example, include a beam. The energy storage device may, for example, include a beam housing. The beam housing may, for example, house the beam. The energy storage device may, for example, include a distributed 2-way piston. The energy storage device may, for example, include a fluid outlet via an electric valve. The energy storage device may, for example, include a fluid inlet via a check valve. The energy storage device may, for example, include a pump. The energy storage device may, for example, include a storage area. The energy storage device may, for example, include a generator. The energy storage device may, for example, include a return to storage area.

### CROSS-REFERENCE TO RELATED APPLICATIONS

This application claims the benefit of U.S. Provisional Application Ser. No. 63/653,665, titled “Mechanical Deflection Energy Storage Device,” filed by Augustine Palena on May 30, 2024.

This application incorporates the entire contents of the foregoing application herein by reference.

### TECHNICAL FIELD

Various embodiments relate generally to energy storage devices.

### BACKGROUND

Energy storage devices may manage energy supply and demand. These devices may include batteries, supercapacitors, and thermal storage systems. Mechanical energy storage devices may store energy in physical forms. Flywheels may store kinetic energy by rotating a mass at high speeds. Pumped hydro storage may use gravitational potential energy by moving water between reservoirs. These mechanical systems may complement chemical and thermal storage. Energy storage devices may enhance overall energy system resilience and flexibility.

### SUMMARY

Apparatus and associated methods relate to an elastic modulus energy storage device. The energy storage device may, for example, include a beam. The energy storage device may, for example, include a beam housing. The beam housing may, for example, house the beam. The energy storage device may, for example, include a distributed 2-way piston. The energy storage device may, for example, include a fluid outlet via an electric valve. The energy storage device may, for example, include a fluid inlet via a check valve. The energy storage device may, for example, include a pump. The energy storage device may, for example, include a storage area. The energy storage device may, for example, include a generator. The energy storage device may, for example, include a return to storage area.

In an illustrative use-case scenario, in an energy storage mode, fluid may, for example, be pumped from a surplus power (e.g., renewable power source, natural gas, day/night cycle) from storage to a fluid inlet. The fluid inlet would direct the flow to the 2-way distributed piston. The piston would press onto a beam, and/or a series of beams. The beam and/or a set of beams may, for example, deflect a predetermined distance within an elastic deformation region. The beams may, for example, deflect up to an elastic yield point. The strain may, for example, vary. The strain may, for example, deform to 0.01-0.5. The strain may, for example, vary based on the dimensions of the steel beam, e.g., length, height, material type. In an energy dispersal mode, the beam may, for example, have a predetermined amount of deflection. The beam housing may, for example, have a predetermined pressure to deflect the container. The inlet valve may, for example, be closed. The outlet valve may, for example, be open. Fluid may, for example, be pumped out of the fluid outlet via electric valve by the pressure differential caused by the beam returning to its original length. The fluid may, for example, be pumped from the stored energy through a generator to generate electricity. The efficiency of the amount of energy input and output may, for example, vary. In an ideal case, the percentage will be close to 100%. The energy retention rate may, for example, include 95%. The energy retention rate may, for example, include 70%. The energy retention rate may, for example, include 90%.

Various embodiments may achieve one or more advantages. For example, some embodiments may provide efficient energy storage and retrieval by utilizing the elastic deformation of beams to store mechanical energy. The system may, for example, offer a higher energy density compared to traditional mechanical storage systems. Some embodiments may, for example, reduce energy loss due to minimal mechanical friction and heat generation. The modular nature of the system may, for example, allow for easy scalability and maintenance. In addition, the use of surplus power sources may, for example, enhance the sustainability and cost-effectiveness of the energy storage device.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary mechanical deflection energy storage device employed in an illustrative use-case scenario.

FIG. 2A depicts an exemplary labeled mechanical deflection storage energy device.

FIG. 2B depicts an exemplary schematic depicting a stress-strain graph, wherein the mechanical deflection energy storage device would operate in the elastic region.

FIG. 3 depicts an exemplary schematic of an exemplary mechanical deflection storage device.

FIG. 4 depicts an illustrative perspective view of an exemplary mechanical deflection storage energy device.

FIG. 5 depicts an illustrative right-side view of an exemplary mechanical deflection storage energy device.

FIG. 6 depicts an illustrative left-side view of an exemplary mechanical deflection storage energy device.

FIG. 7 depicts an illustrative front-side view of an exemplary mechanical deflection storage energy device.

FIG. 8 depicts an illustrative back-side view of an exemplary mechanical deflection storage energy device.

FIG. 9 depicts an illustrative embodiment of an exemplary mechanical deflection storage energy device.

### Like reference symbols in the various drawings indicate like elements.

### DETAILED DESCRIPTION OF ILLUSTRATIVE EMBODIMENTS

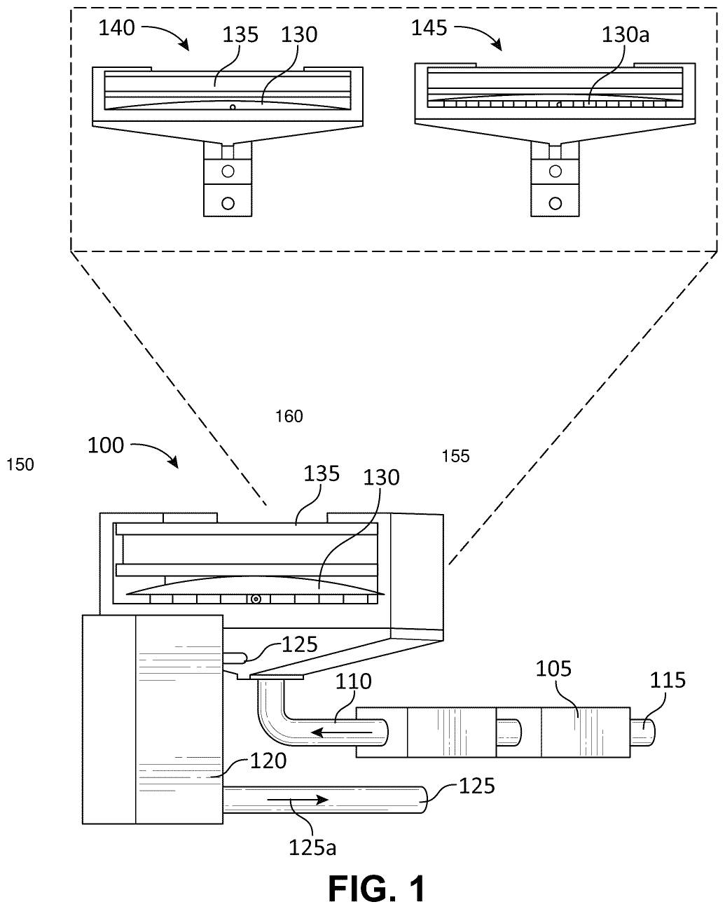

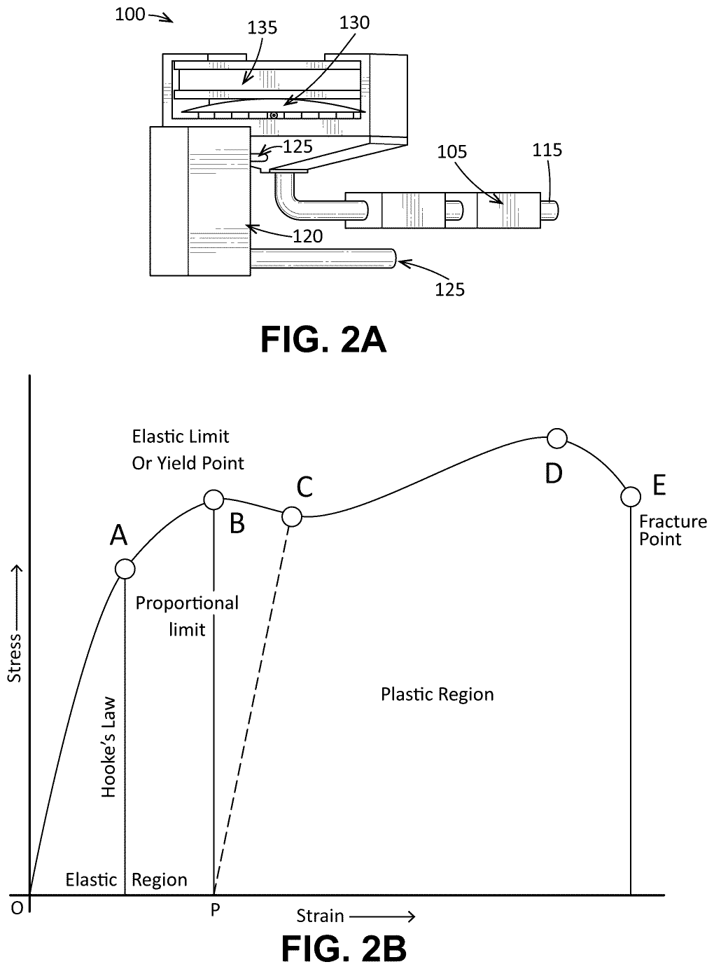

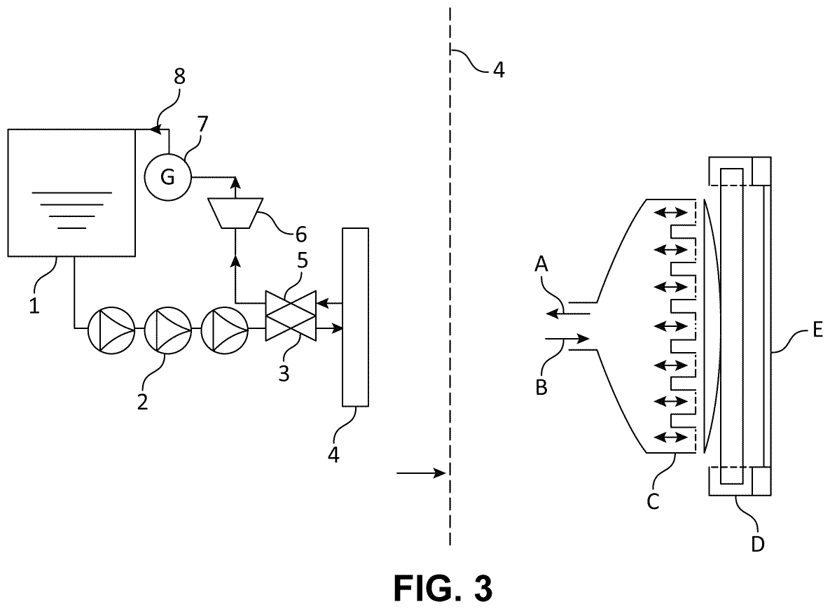

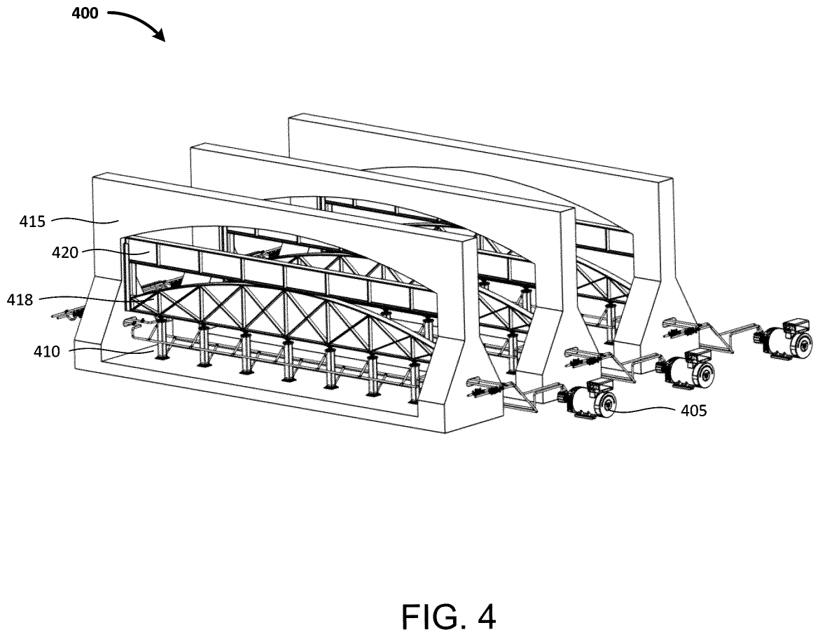

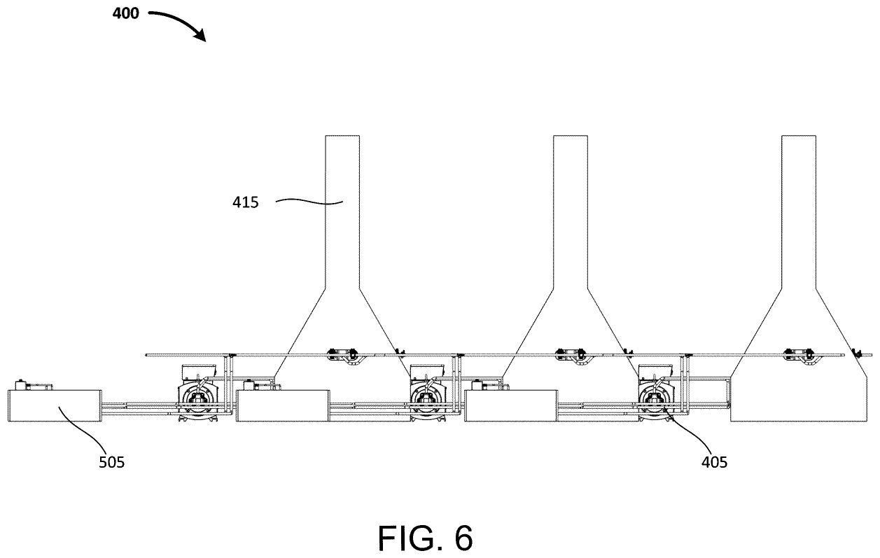

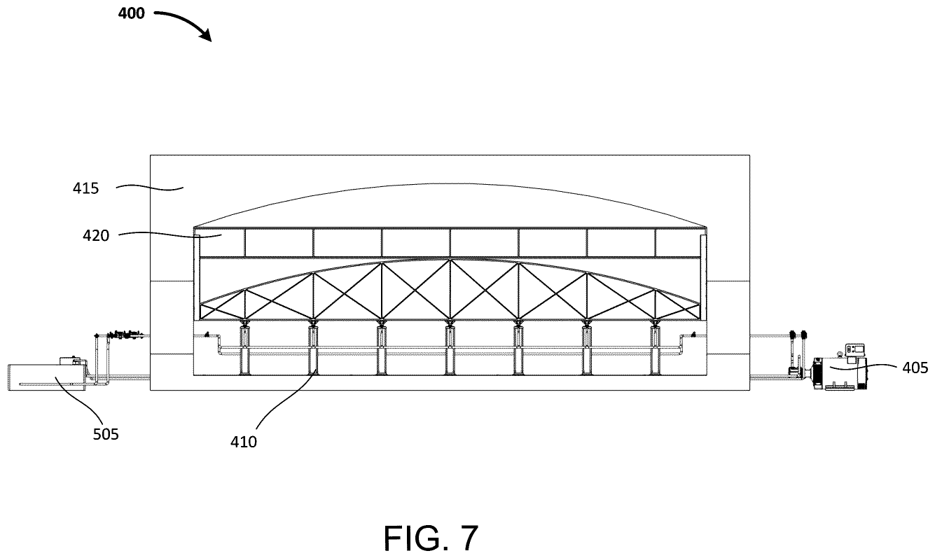

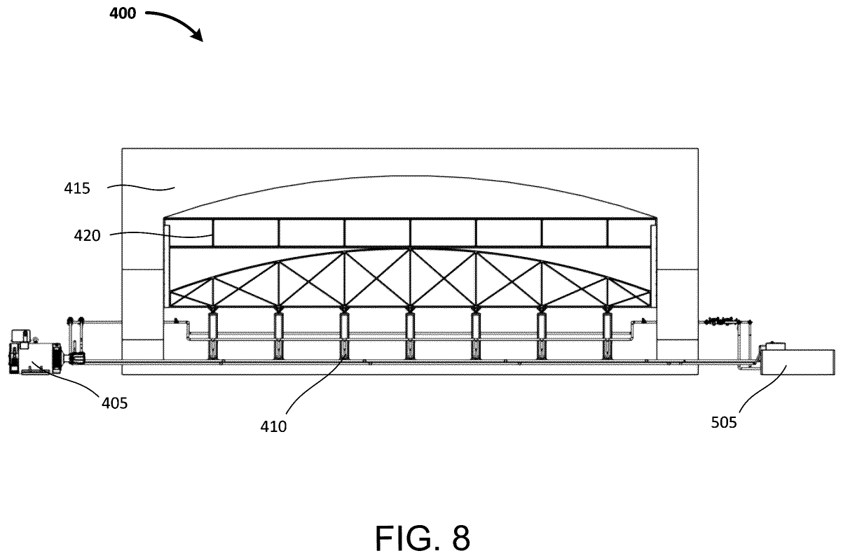

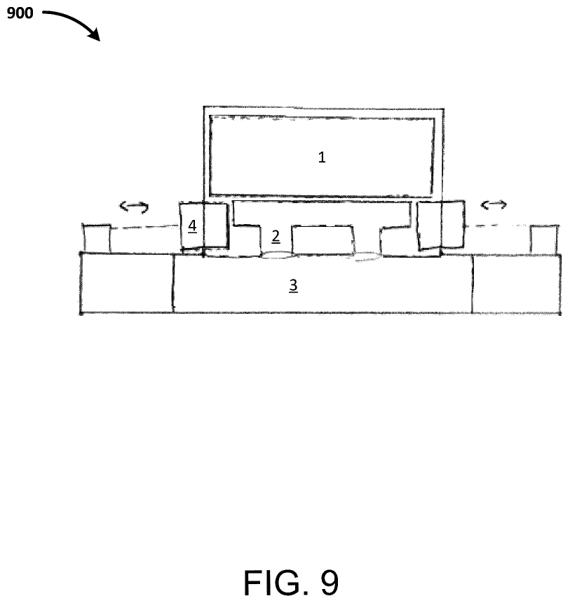

To aid understanding, this document is organized as follows. First, to help introduce the discussion of various embodiments, a mechanical deflection energy storage device is introduced in a use-case scenario with reference to FIG. 1. Second, that introduction leads into a description with reference to FIGS. 2A and 2B of some exemplary embodiments of the mechanical deflection energy storage device and its stress-strain characteristics, operating in the elastic region. Third, with reference to FIG. 3, an exemplary schematic of a mechanical deflection energy storage device is described in application to exemplary use-case scenarios. Fourth, with reference to FIGS. 4-8, an exemplary embodiment of a mechanical deflection energy storage device is described. Fifth, with reference to FIG. 9, an illustrative mechanical energy storage device is depicted and described.

FIG. 1 depicts an exemplary mechanical deflection energy storage device employed in an illustrative use-case scenario 100. The illustrative use-case scenario 100 includes a pump 105. The pump 105 is pumping fluid 110. In some embodiments the fluid 110 may, for example, be incompressible. In some embodiments, the fluid 110 may, for example, be compressible, e.g., a gas. The fluid 110 is flowing from a storage 115 at high pressure (HP). The fluid flows into a fluid inlet via a check valve. The fluid 110 is directed toward a distributed two-way piston 130. The piston 130 is applying force to deflect the beam 135 in an energy storing mode. In an energy release mode, the beam is allowed to return to its original length to apply pressure and fluid flow through a generator 120 through a fluid outlet valve 125. The fluid 125a in an energy release mode flow to storage 125 at low pressure. A dormant mode 140 is depicted in a close-up view in FIG. 1 The dormant mode includes the beam 135 and the two-way pistons 130. The dormant mode is when the beam is not in an energy stored mode and/or a released mode. The dormant mode may, for example, be used after the energy is released until it is reflected. This may, for example, be cyclical and/or be used to store energy from solar panels, and renewables that may produce more energy during sunlight.

FIG. 1 includes a depiction of an energy storage mode 145. The energy storage mode depicted the pistons in an actuated state 130a. The actuated pistons deflect the beam in the elastic state. In an energy release mode, the actuated pistons would revert to a dormant state 140. The energy released from the beam returning to its original length would be used to pump the fluid through the outlet fluid valve 125, as the fluid would be used to spin a motor within the generator 120 generating electricity.

As depicted in FIG. 1, a beam housing 148 includes a top portion 150. The top portion 150 forms a beam seat 155. The beam 135 may, for example, be configured to press against the beam seat 155. The top portion 150 defines an aperture 160. The aperture 160 may, for example, be configured to receive a portion of the beam 135 as the beam 135 is deflected towards the top portion 150.

In some examples, the beam 135 may be disposed longitudinally in the beam housing 148 positioned against the beam seat 155.

In some embodiments, the mechanical deflection energy storage device may, for example, include a hydraulic-elastic energy storage and release system leveraging elastic potential energy to store large volumes of power for extended periods. In some embodiments, this system pertains to energy storage systems, focusing on a method designed for efficient energy storage through the mechanical deformation of structural beams and controlled energy release.

For context, conventional energy storage methods, such as chemical batteries and kinetic systems like flywheels, may have notable limitations in terms of energy density, environmental sustainability, and long-term storage capability. In some embodiments, existing kinetic energy storage solutions, including those utilizing springs or compressed gases, may not meet the scalability requirements needed for contemporary electrical grid systems.

For context, there is a significant demand for an energy storage system that can efficiently store and retrieve substantial energy quantities over long periods without significant degradation while minimizing environmental impacts.

In some embodiments, the disclosed energy storage and release system employs hydraulic pressure to induce mechanical deformation of a selected beam or spanning structure up to its elastic limit. In some embodiments, this deformation stores energy as elastic potential within a sealed hydraulic circuit. In some embodiments, the inventive system preserves this stored energy for extended durations, allowing for its controlled release into a secondary hydraulic circuit upon demand. In some embodiments, this system presents a sustainable and efficient solution to energy storage and management challenges. In some embodiments, the system integrates into the electrical grid through a closed circuit encompassing a fluid reservoir, a series of pumps, input valves, two-way hydraulic pistons, elastic beams with supporting structures, and output valves.

In some embodiments, the operation of the system is delineated into three primary zones: pressure accumulation, pressure storage, and pressure discharge. The system may leverage fundamental principles of material science, focusing on properties such as Young's Modulus and Yield Strength. For context, Young's Modulus quantifies a material's resistance to dimensional changes under tensile or compressive stress, whereas Yield Strength represents the maximum stress a material can withstand while maintaining its elastic behavior.

In some embodiments, the selection of materials with appropriate Yield Strength and Young's Modulus is crucial for achieving desired structural and elastic properties. Materials like steel may be characterized by high yield strength and Young's Modulus, exhibit significant strength but limited elasticity. Materials such as fiberglass may offer an optimal balance of structural integrity and elasticity, making them ideal for the envisioned energy storage application.

In some embodiments, the system's core concept exploits the incompressibility of fluids within hydraulic systems to transfer and store energy. In some embodiments, envisioning a scenario where an external pump exerts fluid pressure on a piston positioned above an I-beam, the system induces bending in the beam once the fluid pressure surpasses a critical threshold.

In some embodiments, this bending allows for a slight increase in the piston chamber's volume, which, when sealed, results in a pressurized state maintained by the beam's inherent tendency to revert to its original shape. The state may effectively store energy at the molecular level, with molecular bonds resisting forces that would otherwise cause permanent deformation. This approach may offer enhanced scalability and cost-efficiency through the geometric and fabrication advantages of beam structures. In some embodiments, the method for storing and releasing energy involves applying hydraulic pressure through a conventional or distributed hydraulic piston system to an I-beam (or other suitable beam) to induce deformation up to the beam's elastic limit. In some embodiments, the deformation stores elastic potential energy within the beam against the hydraulic fluid. Some embodiments may maintain the deformation of the beam for a predetermined period to store the elastic potential energy of the beam.

In some embodiments, the stored elastic potential energy is released by reducing the hydraulic pressure, causing the beam to return to its original shape and transferring the energy into a separate hydraulic system for use. In some embodiments, the I-beam (or other beam) is composed of a material selected for its specific elastic properties to maximize energy storage capacity and efficiency, optimizing around Young's Modulus and Yield Strength. In some embodiments, the system for storing and releasing energy includes a distributed hydraulic piston system configured to apply pressure to an I-beam (or other suitable beam) to deform the beam to its elastic limit. In some embodiments, a support structure is designed to hold the deformed beam securely for an extended period, thereby storing energy in the form of elastic potential energy.

In some embodiments, a control mechanism releases the stored energy by allowing the beam to return to its original shape, transferring the energy into a separate hydraulic system. In some embodiments, the system further includes a feedback mechanism for monitoring the state of deformation of the beam and adjusting the hydraulic pressure accordingly to maintain the deformation within desired parameters, where elastic limit pressure is greater than or equal to applied pump pressure. In some embodiments, the separate hydraulic system is connected to an energy conversion device capable of converting the hydraulic energy into electrical energy or mechanical work. In some embodiments, the hydraulic-elastic energy storage system employs hydraulic pistons to deform a suitable beam to its elastic limit, storing energy for extended periods and releasing it on command into a separate energy-generating hydraulic system.

In some embodiments, the reservoir stores hydraulic fluid, while pumps with a diameter a predetermined dimension pump hydraulic fluid from the reservoir. In some embodiments, input check valves allow fluid to flow from pumps through valves when pump pressure is greater than inner pressure, preventing backflow. In some embodiments, the hydraulic beam system includes pressure release mechanisms, pressure inlets, two-way distributed pistons, an I-beam, and supporting structures. In some embodiments, the pressure release is controlled by an electronic valve opened during discharge, while pressure inlets allow fluid to enter but not leave the hydraulic system. In some embodiments, distributed pistons spread out total pressure, bending the beam or being compressed by it depending on flow direction.

In some embodiments, the I-beam is made of a material with high yield strength and low Young's Modulus, bent to its elastic maximum point as a store of energy. In some embodiments, the structure locks the ends of the beam in place, keeping it stationary. In some embodiments, output valves act as pressure release valves controlled remotely, while a pressure controller standardizes the pressure and velocity of discharge. In some embodiments, the generator converts high-pressure fluid into mechanical energy, and a return mechanism channels fluid back to the reservoir.

In some embodiments, the model shows the primary components of the system and method. In some embodiments, starting from the storage tank, pumps pressurize hydraulic fluid to apply pressure across a distributed piston system onto a beam. In some embodiments, the angle of the piston contact point conforms to the maximum deflection angle of the beam. In some embodiments, the system at a relaxed state shows pumps using the external power grid to pump hydraulic fluid from an input pipe into the distributed hydraulic system. In some embodiments, as the fluid is incompressible, it entices the piston to bend the beam as long as the external pressure is greater than the internal pressure created by the beam. In some embodiments, the pressurized fluid discharges through the generator when prompted by opening the output valve.

FIG. 2A depicts an exemplary labeled mechanical deflection storage energy device.

As depicted in FIG. 2A, some embodiments may, for example, include the generator 120 integrated into the mechanical deflection storage energy device to convert stored mechanical energy into electrical energy. This generator 120 may utilize the motion generated by the mechanical deflection to produce electricity. The mechanical deflection storage energy device's generator 120 may be designed for high efficiency and reliability.

As depicted in FIG. 2A, some embodiments may, for example, include the pumps 105 that circulate fluid within the mechanical deflection storage energy device. These pumps 105 may ensure that fluid is moved from storage (HP) to various parts of the system as needed. The mechanical deflection storage energy device's pumps 105 may be critical for maintaining the necessary pressure and flow rates for optimal performance.

As depicted in FIG. 2A, some embodiments may, for example, include the beam 135 and the beam housing that form the core of the mechanical deflection storage energy device. The beam 135 may be deflected under pressure, storing mechanical energy in the process. The mechanical deflection storage energy device's beam housing may provide structural support and guide the motion of the beam 135, ensuring efficient energy storage and release.

As depicted in FIG. 2A, some embodiments may, for example, include distributed 2-way pistons within the mechanical deflection storage energy device. These pistons may facilitate the bidirectional movement of fluid, contributing to the device's ability to store and release energy. The mechanical deflection storage energy device's distributed 2-way pistons may enhance the overall functionality and efficiency of the system.

As depicted in FIG. 2A, some embodiments may, for example, include an electric valve that controls the fluid outlet in the mechanical deflection storage energy device. This electric valve may precisely manage the discharge of fluid, ensuring controlled energy release. The mechanical deflection storage energy device's electric valve may be critical for maintaining operational stability and safety.

As depicted in FIG. 2A, some embodiments may, for example, include a check valve that regulates the fluid inlet in the mechanical deflection storage energy device. This check valve may prevent backflow and ensure that fluid enters the system correctly. The mechanical deflection storage energy device's check valve may be essential for maintaining proper fluid dynamics and preventing operational issues.

As depicted in FIG. 2A, some embodiments may, for example, include a return line that channels fluid back to storage (LP) within the mechanical deflection storage energy device. This return line may ensure that fluid is efficiently cycled back to the reservoir for reuse. The mechanical deflection storage energy device's return line may help maintain system pressure and readiness for subsequent energy storage cycles.

FIG. 2B depicts an exemplary schematic depicting a stress-strain graph, wherein the mechanical deflection energy storage device would operate in the elastic region.

Some embodiments may, for example, include a mechanical deflection energy storage device operating within the elastic region, specifically adhering to Hooke's Law. This mechanical deflection energy storage device may ensure that the stress applied to the material remains proportional to the strain, maintaining the integrity of the device. Operating in the elastic region, the mechanical deflection energy storage device may effectively store and release energy without permanent deformation.

Some embodiments may, for example, include the mechanical deflection energy storage device reaching the proportional limit, marked by point A on the graph. This mechanical deflection energy storage device may demonstrate optimal energy storage capabilities within this proportional limit, ensuring maximum efficiency. The mechanical deflection energy storage device may be designed to avoid surpassing this limit to maintain its operational reliability and longevity.

Some embodiments may, for example, include the mechanical deflection energy storage device operating well below the elastic limit or yield point, represented by point B on the graph. This mechanical deflection energy storage device may be calibrated to function efficiently within these bounds, preventing any transition into the plastic region. By maintaining operations within the elastic region, the mechanical deflection energy storage device may ensure reversible deformation and consistent performance.

FIG. 3 depicts an exemplary schematic of an exemplary mechanical deflection storage device. As depicted in FIG. 3, some embodiments may, for example, include a reservoir (1) to store the working fluid essential for the device's operation. This mechanical deflection storage device may ensure that the fluid in the reservoir is kept at optimal levels for efficient energy storage. The reservoir in the mechanical deflection storage device may also act as a buffer to manage the fluid's thermal expansion and contraction.

As depicted in FIG. 3, some embodiments may, for example, include pumps (2) to circulate the working fluid throughout the system. These pumps in the mechanical deflection storage device may be designed to handle varying pressures and flow rates. The mechanical deflection storage device's pumps may also contribute to the regulation of the fluid's movement, ensuring consistent performance.

As depicted in FIG. 3, some embodiments may, for example, include input check valves (3) to control the fluid's entry into the system. These input check valves may prevent backflow, which is crucial for maintaining the mechanical deflection storage device's efficiency. The mechanical deflection storage device's input check valves may also be strategically placed to optimize fluid dynamics.

As depicted in FIG. 3, some embodiments may, for example, include a hydraulic and/or beam system (4) as the core mechanism for energy storage and release. This system may involve the deflection of beams under pressure, converting mechanical energy into stored energy. The mechanical deflection storage device's hydraulic and/or beam system may also be designed to return to its original position, ready for the next cycle.

As depicted in FIG. 3, some embodiments may, for example, include outlet valves (5) to regulate the discharge of fluid from the system. These outlet valves may be synchronized with the pumps to maintain balanced pressure. The mechanical deflection storage device's outlet valves may also ensure that the energy release process is controlled and efficient.

As depicted in FIG. 3, some embodiments may, for example, include a pressure controller (6) to monitor and adjust the internal pressure levels. This pressure controller may respond to varying operational conditions to optimize performance. The mechanical deflection storage device's pressure controller may also provide safety mechanisms to prevent overpressure scenarios.

As depicted in FIG. 3, some embodiments may, for example, include a generator (7) to convert the stored mechanical energy into electrical energy. This generator may be driven by the movement of fluid or mechanical components. The mechanical deflection storage device's generator may also include features to optimize energy conversion efficiency.

As depicted in FIG. 3, some embodiments may, for example, include a return valve (8) to manage the fluid's return to the reservoir. This return valve may ensure a smooth and continuous flow back to the reservoir after energy discharge. The mechanical deflection storage device's return valve may also help maintain system pressure and readiness for the next cycle.

As depicted in FIG. 3, some embodiments may, for example, include pressure release (A) mechanisms to manage excess pressure. These pressure release systems may protect the device from potential damage due to overpressure. The mechanical deflection storage device's pressure release may also be a critical component for ensuring safe operation.

As depicted in FIG. 3, some embodiments may, for example, include a pressure inlet (B) to control the entry of pressurized fluid into the system. This pressure inlet may be designed to handle high-pressure conditions to maximize energy storage. The mechanical deflection storage device's pressure inlet may also be integrated with other components to maintain fluid integrity.

As depicted in FIG. 3, some embodiments may, for example, include a 2-way distributed piston (C) to facilitate bidirectional fluid movement. This piston may allow for efficient energy storage and release cycles. The mechanical deflection storage device's 2-way distributed piston may also enhance the overall functionality and versatility of the system.

As depicted in FIG. 3, some embodiments may, for example, include an I-Beam (D) as part of its structural support. This I-Beam may provide the necessary rigidity and strength to withstand operational stresses. The mechanical deflection storage device's I-Beam may also be designed to integrate seamlessly with other components, ensuring structural integrity.

As depicted in FIG. 3, some embodiments may, for example, include a structure (E) that encompasses all components, providing a cohesive and robust framework. This structure may be engineered to support both static and dynamic loads during operation. The mechanical deflection storage device's structure may also ensure durability and longevity, even under varying operational conditions.

In some embodiments, the schematic includes various components such as fluid storage, pumps, a generator, an outlet electronic valve, an inlet check valve, steel cables, a cable tether, a distribution piston, hydraulic housing, a truss structure, and a primary beam.

In some embodiments, fluid storage may, for example, store the working fluid required for the mechanical deflection energy storage device. Fluid storage may be essential for maintaining the operational fluid levels necessary for energy conversion processes. Pumps may, for example, circulate the fluid from the storage through the system, ensuring consistent flow and pressure. Pumps may be designed to handle high-pressure conditions to optimize the mechanical deflection energy storage device's efficiency. Different types of pumps, such as centrifugal or positive displacement pumps, may be used depending on the specific requirements of the system. The choice of pump may affect the overall efficiency and reliability of the energy storage device.

In some embodiments, the generator may, for example, convert the stored mechanical energy into electrical energy. The generator may be powered by the movement of fluid or mechanical components, such as the deflection of beams. The outlet electronic valve may, for example, control the release of fluid from the system, ensuring precise regulation of pressure and flow. The outlet electronic valve may be crucial for managing the energy release process efficiently. Alternative embodiments may use different types of valves, such as solenoid or pneumatic valves, depending on the control requirements. The integration of sensors and control systems may enhance the precision and responsiveness of the valve operations.

In some embodiments, the inlet check valve may, for example, prevent backflow of fluid into the storage, ensuring unidirectional flow. The inlet check valve may be critical for maintaining the fluid dynamics required for optimal performance. Steel cables may, for example, provide structural support and assist in the mechanical deflection process. Steel cables may be designed to withstand high tensile forces and contribute to the overall stability of the device. The use of advanced materials, such as carbon fiber composites, may improve the strength-to-weight ratio of the cables. The arrangement of cables may be optimized to distribute loads more effectively across the structure.

In some embodiments, the cable tether may, for example, secure the steel cables to the primary beam or other structural components. The cable tether may ensure that the mechanical deflection energy storage device remains stable during operation. The distribution piston may, for example, facilitate the bidirectional movement of fluid within the system. The distribution piston may enhance the device's ability to store and release energy efficiently. Hydraulic pistons of varying sizes and configurations may be used to accommodate different force requirements. The design of the piston seals may be optimized to minimize leakage and maximize durability.

In some embodiments, the hydraulic housing may, for example, enclose the hydraulic components and provide a sealed environment for fluid movement. The hydraulic housing may protect the internal components from external elements and ensure smooth operation. The truss structure may, for example, provide additional support to the primary beam, helping to resist deflection and maintain structural integrity. The truss structure may be designed using principles of structural engineering to maximize load-bearing capacity. Modular truss designs may allow for easy assembly and disassembly, facilitating maintenance and scalability.

Notes in the schematic discuss major improvements, the general mechanism, and the primary objective of “maximizing beam deflection with minimal large components.” In some embodiments, the major improvement may involve building resistant structures around the main beam to maximize carrying capacity. Structures may deflect more dramatically with a smaller amount of the main beam. The primary methods may involve using cables similar to those in a cable-stay bridge, where the main beams with cables tied to a foundation may deflect, and cables may deflect. The integration of sensors and control systems may provide real-time monitoring and adjustment of deflection. Smart materials that respond to external stimuli may be employed to enhance the dynamic performance of the deflection mechanism.

In some embodiments, the truss support structure may be added to resist beam deflection and heavily deflect with small main beam deflection. The truss structure may take a larger force to deflect the beam, resulting in a larger total deflection with a minimal amount of beam deflection. This improvement may raise total capacity without any individual part being too large. The primary issue in previous designs, such as the beam sagging due to its length, may be addressed with this approach. Alternative truss configurations, such as space frames or geodesic domes, may provide enhanced stability and load distribution. The use of adjustable trusses may allow for real-time optimization of structural performance under varying loads.

In some embodiments, the general mechanism may involve fluid in the reservoir being driven through hydraulic pumps powered by external grid energy. The fluid may enter through the check valve into the hydraulic piston chamber, noting the check valve and pipe tool used to prevent undesirable chamber pressure. Adding incompressible fluid into the chamber may cause pistons to extend. The extension may cause deflection up to the elastic limit within the beam structure and truss structure. The system may include pressure sensors to monitor and control the fluid pressure within the piston chambers. The use of hydraulic accumulators may store excess energy and release it when needed to smooth out fluctuations in system performance.

In some embodiments, the system may be able to hold pressure indefinitely at this point. The pressurized fluid may be released into the generator to generate power via the electronic outlet valve. After the energy is extracted from the fluid, the fluid may return to the reservoir. The design may include a cooling system to manage the heat generated during the energy conversion process. The use of regenerative braking systems may capture energy during the deceleration phase and store it for future use. The integration of energy management systems may optimize the overall efficiency and performance of the mechanical deflection energy storage device.

The schematic includes a fluid storage, generator, pumps, cable tether, inlet valve, steel cables, outlet valve, distributed pistons, cables, beam, and split arch. In some embodiments, the fluid storage may hold the working fluid necessary for the system's operation. Pumps may circulate the fluid from storage, maintaining consistent pressure and flow. The generator may convert mechanical energy into electrical energy, driven by fluid movement or mechanical deflection. The system may include a control panel for monitoring and adjusting operational parameters. The incorporation of safety features, such as pressure relief valves, may prevent accidental overpressure conditions.

In some embodiments, the cable tether may secure the steel cables, ensuring stability during operation. The inlet valve may control fluid entry into the system, preventing backflow and maintaining proper flow direction. Steel cables may provide structural support, enhancing the system's stability and performance. The outlet valve may regulate fluid discharge, ensuring efficient energy release. The use of advanced computational modeling may optimize the design and performance of the system components. The integration of renewable energy sources, such as solar panels, may provide additional power to the system.

In some embodiments, distributed pistons may facilitate bidirectional fluid movement, optimizing energy storage and release cycles. The cables may assist in the deflection process, contributing to the system's efficiency. The beam may be the primary structural component, designed to deflect under pressure. The split arch may provide additional structural support, aiding in deflection and energy storage. The system may include feedback mechanisms to adjust the position and tension of the cables dynamically. The use of lightweight, high-strength materials may reduce the overall weight of the system while maintaining structural integrity.

In some embodiments, the system may operate in various stages of fluid flow, as depicted in the schematic. The fluid storage may hold the necessary working fluid, which is circulated by the pumps. The generator may convert mechanical energy into electrical energy. The cable tether may secure the cables, ensuring stability during operation. The inlet valve may control fluid entry, while the outlet valve may regulate fluid discharge. The system may include automated control systems to manage the timing and sequencing of fluid flow. The integration of predictive maintenance technologies may enhance the reliability and lifespan of the system.

In some embodiments, the distributed pistons may facilitate bidirectional fluid movement, optimizing energy storage and release. The steel cables may provide structural support, aiding in the deflection process. The beam may be the primary structural component, designed to deflect under pressure. The split arch may provide additional support, ensuring efficient energy storage and release. The system may incorporate advanced materials, such as shape memory alloys, to enhance the deflection and recovery properties of the beam. The use of modular design principles may allow for easy scaling and customization of the system to meet specific application requirements.

In some embodiments, as depicted a schematic of the energy storage device, includes a reservoir, pumps, generator, inlet valve, pistons, beams, outlet valve, archons, cables, and/or a beam holder. The reservoir may store the working fluid, while the pumps may circulate it through the system. The generator may convert mechanical energy into electrical energy. The inlet valve may control fluid entry, and the outlet valve may regulate discharge. The system may include sensors to monitor fluid levels, pressure, and temperature in real-time. The use of smart grid technologies may enable the integration of the energy storage device with existing power networks.

In some embodiments, the pistons may facilitate fluid movement, enhancing energy storage and release cycles. The beams may be designed to deflect under pressure, storing mechanical energy. The archons may provide structural support, aiding in the deflection process. The cables may offer additional support, ensuring stability and efficiency. The beam holder may secure the beams, maintaining structural integrity. The design may include redundant systems to ensure continuous operation in case of component failure. The integration of IoT (Internet of Things) technologies may enable remote monitoring and control of the energy storage device.

The schematic discusses truss structure scalability, with tension/compression beams elastically bent to hold pressure in pistons, joints bending, and theoretically infinite volume of truss applied atop shown truss. In some embodiments, the truss structure may be scalable, allowing for adjustments based on operational requirements. Tension/compression beams may be elastically bent, holding pressure within the pistons. The joints may bend to accommodate the deflection process. The truss structure may theoretically support an infinite volume, applied atop the existing truss configuration. This scalability may enhance the system's capacity, allowing for increased energy storage and release. The use of advanced manufacturing techniques, such as 3D printing, may facilitate the production of complex truss structures. The integration of real-time monitoring systems may optimize the performance and safety of the truss structure.

In some embodiments, maximizing beam deflection with minimal large components may be a key objective. The system may involve the integration of resistant structures around the main beam, which deflects more dramatically with a smaller amount of the main beam. Cables may be used to assist in the deflection process, providing additional support and stability. The truss structure may aid in resisting beam deflection while allowing for increased capacity and efficiency. The use of adaptive control systems may adjust the tension in the cables and truss elements in response to changing load conditions. The incorporation of energy-efficient materials may reduce the overall environmental impact of the system.

In some embodiments, the fluid reservoir may drive hydraulic pumps, which circulate the fluid through the system. The fluid may enter the hydraulic piston chamber through the check valve, preventing undesirable pressure buildup. Adding incompressible fluid into the chamber may cause pistons to extend, deflecting the beam up to the elastic limit. The system may hold pressure indefinitely, with the pressurized fluid released into the generator to produce power. The design may include energy recovery systems to capture and reuse waste energy from the hydraulic and mechanical processes. The integration of advanced simulation tools may optimize the design and performance of the entire energy storage system.

In some embodiments, the fluid may return to the reservoir after energy extraction, completing the cycle. The system's design may ensure optimal performance, efficiency, and stability, with a focus on maximizing beam deflection and minimizing large components. The integration of various components, such as the fluid storage, pumps, generator, valves, cables, and truss structure, may contribute to the system's overall functionality and effectiveness. The use of advanced diagnostics and maintenance tools may extend the lifespan of the system and reduce operational costs. The adoption of sustainable design principles may enhance the environmental and economic benefits of the mechanical deflection energy storage devices.

FIG. 4 depicts an illustrative perspective view of an exemplary mechanical deflection storage energy device. A device 400 includes a hydraulic pump 405. The hydraulic pump 405 is pumping fluid. The fluid is flowing from a pump reservoir at a HP. The fluid flows into a fluid inlet valve via a check valve. The fluid is directed towards actuators 410 arranged in a housing 415. The actuators 410 apply force on a pushing buck weldment 418 to deflect a strut 420 in an energy storing mode. In an energy release mode, the strut 420 is allowed to return to its original length to apply pressure through a generator 425 through a fluid outlet valve. The fluid in an energy release mode flow to storage at low pressure. In some embodiments, the actuators 410 apply equal and simultaneous pressure on the pushing buck weldment 418. This may, in some examples, advantageously enable the actuators to deform the strut 420 with equal force and apply the force to a wider area on the strut 420. This may, for example, advantageously prevent fracture of the strut 420.

In various embodiments, the device 400 includes an electronic solenoid valve configured to allow pressure to be released from the device 400. This may, for example, advantageously decrease the force being applied by the actuators 410 and allow for the strut 420 to return to its normal position.

In some implementations, the device 400 includes backflow prevention valves. The backflow prevention valves may, for example, prevent the reverse flow of fluid in the device 400. This may, in some examples, advantageously enable the actuators 410 to maintain pressure on the strut 420.

In various implementations, a hydraulic-elastic energy storage system includes a distributed hydraulic piston system configured to apply force to a structural beam, such as an I-beam, thereby deforming the beam to or near its elastic limit; wherein said deformation stores energy in the form of elastic potential energy within the beam; and a controlled release device configured to reduce the hydraulic pressure, allowing the beam to revert to its original shape, thereby displacing fluid into a secondary hydraulic system connected to a generator or energy output device.

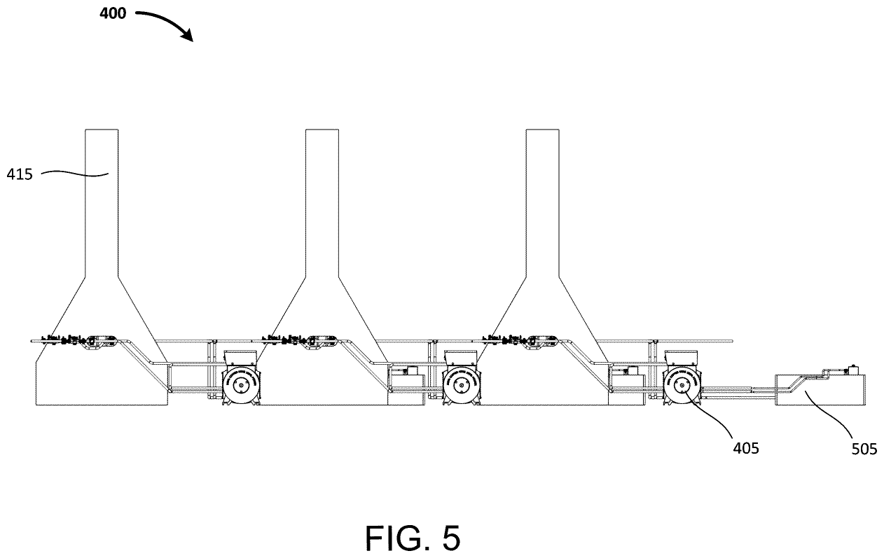

FIG. 5 depicts an illustrative right-side view of an exemplary mechanical deflection storage energy device. The device 400 includes a reservoir tank 505. The reservoir tank 505 may, for example, store fluid to be used by the hydraulic pump 405 to drive the actuators 410 to deform the strut 420.

FIG. 9 depicts an illustrative embodiment of an exemplary mechanical deflection storage energy device. Arrangement 900 includes a deformation system 1 and a piston system 2 configured to deflect the deformation system 1. A pressure chamber 3 may, for example, be configured to pressurize the piston system 2 to drive the deflection of the deformation system 1. The arrangement 900 includes a support 4. The support 4 may, for example, be configured to be positioned when the deformation system 1 is at maximum deformation and the piston system 2 is fully extended. The support 4 may, for example, advantageously be positioned to bear the tension pressure from the deformation system. The support 4 may, in some aspects, be positioned using external controls. This may, in some examples, advantageously reduce the wear on the piston system 2.

Although various embodiments have been described with reference to the figures, other embodiments are possible.

Although an exemplary system has been described with reference to FIGS. 1-9, other implementations may be deployed in other industrial, scientific, medical, commercial, and/or residential applications.

In industrial applications, a mechanical deflection energy storage device may be used in manufacturing plants to store surplus energy generated during low-demand periods. In industrial applications, the device can store energy from machines in motion, utilizing the beam's deflection to capture and store kinetic energy. In industrial applications, during peak demand, the stored energy may be released to power industrial equipment, thereby balancing energy loads and reducing operational costs. In industrial applications, the robust nature of the beam and housing allows the device to withstand harsh industrial environments. In industrial applications, maintenance may be minimized due to the modular design of the storage system, enhancing reliability and efficiency.

In scientific applications, a mechanical deflection energy storage device may be used to store energy from experimental apparatus. In scientific applications, equipment that generates intermittent energy, like particle accelerators, may transfer surplus energy to the device. In scientific applications, the beam's deflection can efficiently store this energy, which may later be used to power other research instruments. In scientific applications, this system's ability to store and release energy with minimal loss makes it ideal for sensitive scientific equipment. In scientific applications, the scalability of the device allows it to adapt to various experimental setups, providing a reliable and cost-effective energy storage solution.

In medical applications, a mechanical deflection energy storage device may be used in hospitals to store energy from various medical equipment. In medical applications, the device can capture surplus energy from diagnostic machines, such as MRI scanners, which often operate intermittently. In medical applications, this stored energy may then be used during peak times to ensure a consistent power supply, critical for life-saving equipment. In medical applications, the reliable and efficient nature of the beam deflection system reduces the risk of power disruptions. In medical applications, the device's ability to minimize energy loss and its scalability ensure that it can meet the diverse energy needs of medical facilities.

In commercial applications, a mechanical deflection energy storage device may be used in office buildings and retail centers to manage energy consumption effectively. In commercial applications, the device can store energy from HVAC systems and lighting during off-peak hours. In commercial applications, this energy can then be released during peak hours to reduce electricity costs and demand charges. In commercial applications, the beam deflection system's efficiency in storing and releasing energy helps maintain a stable power supply, enhancing operational efficiency. In commercial applications, the modular design of the system allows for easy integration into existing building infrastructures, ensuring a seamless addition to energy management strategies.

In residential applications, a mechanical deflection energy storage device may be used in homes to store energy from renewable sources such as solar panels. In residential applications, the device can capture surplus energy generated during the day and store it for use during the evening or night. In residential applications, this helps homeowners reduce reliance on the grid and lower electricity bills. In residential applications, the beam's deflection mechanism ensures efficient energy storage and retrieval, making it a practical solution for residential energy management. In residential applications, the device's compact and scalable design allows it to be easily installed in homes of various sizes, providing a flexible energy storage option for residential use.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated.

What is claimed is:

1. An energy storage system comprising:
at least one piston arranged within a housing;
the housing having a top portion;
the top portion defining a beam seat;
a beam disposed longitudinally in the housing positioned against the beam seat;
the beam seat being configured to receive the beam;
the at least one piston being configured to reversibly deform the beam to store energy.

2. The energy storage system of claim 1, wherein the top portion defines an aperture.

3. The energy storage system of claim 2, wherein the beam is configured to deform into the aperture.

4. The energy storage system of claim 1, wherein the at least one piston is fluidly coupled to a pump pumping fluid from a storage at a high pressure.

5. The energy storage system of claim 4, wherein the fluid is configured to drive the at least one piston to deform the beam in an energy storing mode.

6. The energy storage system of claim 4, wherein the beam is configured, upon reversing the deformation, to pump the fluid through an outlet fluid valve.

7. The energy storage system of claim 6, wherein the fluid passing through the outlet fluid valve spins a motor within a generator to generate electricity.

8. The energy storage system of claim 6, wherein the reversal of the deformation is controllably reverse by a controlled release device configured to reduce hydraulic pressure.

9. The energy storage system of claim 1, wherein the beam is an I-beam.

10. The energy storage system of claim 1, wherein the beam is made of a material with high yield strength and low Young's Modulus.

11. An energy storage system comprising:
at least one piston arranged within a housing;
the housing having a top portion;
the top portion defining a beam seat;
a beam disposed longitudinally in the housing positioned against the beam seat;
the at least one piston being configured to reversibly deform the beam to store energy.

12. The energy storage system of claim 11, wherein the beam seat is configured to receive the beam.

13. The energy storage system of claim 12, wherein the beam is configured to deform into an aperture.

14. The energy storage system of claim 11, wherein the at least one piston is fluidly coupled to a pump pumping fluid from a storage at a high pressure.

15. The energy storage system of claim 14, wherein the fluid is configured to drive the at least one piston to deform the beam in an energy storing mode.

16. The energy storage system of claim 14, wherein the beam is configured, upon reversing the deformation, to pump the fluid through an outlet fluid valve.

17. The energy storage system of claim 16, wherein the fluid passing through the outlet fluid valve spins a motor within a generator to generate electricity.

18. The energy storage system of claim 11, wherein the reversal of the deformation is controllably reverse by a controlled release device configured to reduce hydraulic pressure.

19. The energy storage system of claim 11, wherein the beam is an I-beam.

20. An energy storage system comprising:
at least one piston arranged within a housing;
the housing having a top portion;
the top portion defining a seat;
means for storing mechanical energy disposed longitudinally in the housing positioned against the seat;
the seat being configured to receive the means for storing mechanical energy;
the at least one piston being configured to reversibly deform the means for storing mechanical energy to store energy.
